(19) United States
(12) Patent Application Publication
(10) Pub. No.: US 2019/0147039 A1
(43) Pub. Date: May 16, 2019

(54) INFORMATION PROCESSING APPARATUS, INFORMATION GENERATION METHOD, WORD EXTRACTION METHOD, AND COMPUTER-READABLE RECORDING MEDIUM

(71) Applicant: FUJITSU LIMITED, Kawasaki-shi (JP)

(72) Inventors: Masahiro Kataoka, Kamakura (JP); SHOUJI IWAMOTO, Yamato (JP); Sakae Inoue, Minami (JP)

(73) Assignee: FUJITSU LIMITED, Kawasaki-shi (JP)

(21) Appl. No.: 16/184,461

(22) Filed: Nov. 8, 2018

(30) Foreign Application Priority Data
Nov. 13, 2017 (JP) 2017-218464

(51) Int. Cl. G06F 17/27

(52) U.S. Cl. CPC G06F 17/2735

(57) ABSTRACT

An information generation method includes: receiving dictionary data used for morpheme analysis; and generating index information indicating relative positions of characters of each character included in a word registered in the dictionary data, a character at a head of the word, and a character at an end of the word based on the received dictionary data, by a processor.

### CROSS-REFERENCE TO RELATED APPLICATION

This application is based upon and claims the benefit of priority of the prior Japanese Patent Application No. 2017-218464, filed on Nov. 13, 2017, the entire contents of which are incorporated herein by reference.

### FIELD

The embodiments discussed herein are related to an information processing apparatus, an information generation method, a word extraction method, and a computer-readable recording medium.

### BACKGROUND

Conventionally, morpheme analysis has been performed for CJK (Chinese, Japanese, Korean) characters to recognize delimiters of morphemes, and then, output character strings of dividable words. For example, there are related arts, such as MeCab and ChaSen, that recognize a delimiter of a morpheme from text and output a character string of dividable words. In the morpheme analysis such as MeCab and ChaSen, a tree and double-array are applied to a morpheme dictionary, and a plurality of dividable word candidates is extracted in two paths. Then, a score is calculated by a word hidden Markov model (HMM) or a conditional random field (CRF) after reaching an end of the text, and word groups obtained by dividing the text are output in order of scores.

Conventionally, in kana-kanji conversion, a forward matching index is applied to a word dictionary peculiar to kana-kanji conversion, word candidates that can be subjected to kana-kanji conversion are displayed based on an input head kana-kanji character or a head kanji after confirmation to perform input assistance. The word candidates that can be subjected to kana-kanji conversion are output in order of scores by calculating scores using, for example, the word HMM or the CRF.

Incidentally, each of the word HMM and the CRF is formed of character code strings.
Patent Document 1 Japanese Laid-open Patent Publication No. 2000-231563
Patent Document 2 Japanese Laid-open Patent Publication No. 2010-231149

### SUMMARY

According to an aspect of the embodiment, an information generation method includes: receiving dictionary data used for morpheme analysis; and generating index information indicating relative positions of characters of each character included in a word registered in the dictionary data, a character at a head of the word, and a character at an end of the word based on the received dictionary data, by a processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an example of processing of an information processing apparatus according to an embodiment;

FIG. 2 is a functional block diagram illustrating a configuration of the information processing apparatus according to the embodiment;

FIG. 3 is a view illustrating an example of a data structure of dictionary data;

FIG. 4 is a view illustrating an example of a data structure of array data;

FIG. 5 is a view illustrating an example of a data structure of an offset table;

FIG. 6 is a view illustrating an example of a data structure of an index;

FIG. 7 is a view illustrating an example of a data structure of an upper index;

FIG. 8 is a view for describing hashing of the index;

FIG. 9 is a view illustrating an example of a data structure of index data;

FIG. 10 is a view for describing an example of a process of restoring a hashed index;

FIG. 11 is a view for describing an example of a process of extracting a word candidate;

FIG. 12 is a diagram for describing an example of a word HMM generation process;

FIG. 13 is a view illustrating an example of a data structure of word HMM data;

FIG. 14 is a view for describing an example of a process of estimating a word;

FIG. 15A is a view (1) for describing an example of a process of extracting a CJK word;

FIG. 15B is a view (2) for describing an example of the process of extracting CJK words;

FIG. 16 is a flowchart illustrating a processing procedure of an index generation unit;

FIG. 17 is a flowchart illustrating a processing procedure of a word HMM generation unit;

FIG. 18 is a flowchart illustrating a processing procedure of a word candidate extraction unit;

FIG. 19 is a flowchart illustrating a processing procedure of a word extraction unit;

FIG. 20 is a flowchart illustrating a processing procedure of a word estimation unit; and

FIG. 21 is a view illustrating an example of a hardware configuration of a computer that realizes the same functions as those of the information processing apparatus.

### DESCRIPTION OF EMBODIMENT(S)

However, the above-described related arts have a problem that it is difficult to efficiently perform commonization of the respective word dictionaries of kana-kanji conversion and morpheme analysis, word extraction, and maximum likelihood estimation when the kana-kanji conversion and the morpheme analysis coexist.

For example, the forward matching index used for the kana-kanji conversion has a different format from the tree and the double-array used for the morpheme analysis, and thus, is not used for the morpheme analysis. That is, it is difficult to extract the plurality of dividable word candidates with the forward matching index used for the kana-kanji conversion. Therefore, there is a need to mix the word dictionary, and the forward matching index with the morpheme dictionary, the tree, and the double-array in order to achieve the two purposes of kana-kanji conversion and morpheme analysis, which makes it difficult to efficiently extract the word candidates that can be subjected to the kana-kanji conversion. Further, it is difficult to efficiently extract character strings of words that can be divided from text even in the morpheme analysis.

Further, the word candidates of the kana-kanji conversion are subjected to maximum likelihood estimation using, for example, the word HMM. However, a size increases as the number of words increase since the word HMM is formed of character code strings. Therefore, cost for the maximum likelihood estimation of words increases in the kana-kanji conversion. That is, it is difficult to efficiently estimate the maximum likelihood of a word in the kana-kanji conversion. Further, the same problem occurs even in the morpheme analysis when extracting character strings of words that can be divided from text and performing maximum likelihood estimation.

Preferred embodiments will be explained with reference to accompanying drawings. Incidentally, the invention is not limited to the embodiments.

### Information Generation Process According to Embodiment

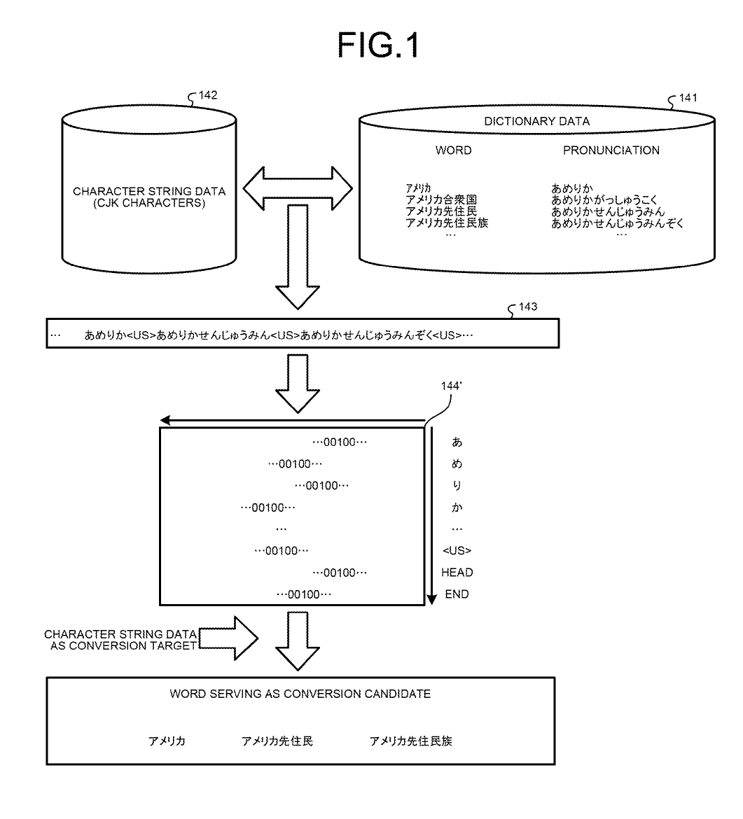

FIG. 1 is a diagram for describing an example of processing of an information processing apparatus according to an embodiment. As illustrated in FIG. 1, the information processing apparatus executes the following processing when extracting a word serving as a kana-kanji conversion candidate. For example, it is assumed that character string data 142 is data of a document including CJK characters. The CJK character corresponds to Chinese, Japanese, or Korean character. Further, dictionary data 141 is the same as dictionary data used for morpheme analysis.

The information processing apparatus compares the character string data 142 with the dictionary data 141. The dictionary data 141 is data defining words (morphemes) serving as kana-kanji conversion candidates.

The information processing apparatus scans the character string data 142 from a head, extracts a character string hit with the word defined in the dictionary data 141, and stores the extracted character string in array data 143.

The array data 143 has words defined in the dictionary data 141 among the character strings included in the character string data 142. <US (unit separator)> is registered as a delimiter between the respective words. For example, the information processing apparatus compares the character string data 142 with the dictionary data 141, and generates the array data 143 illustrated in FIG. 1 in which pronunciations of the hit words are arrayed when “ [symbol] [symbol] ”, “ [symbol] ” and “ [symbol] ” registered in the dictionary data 141 are hit in this order.

When generating the array data 143, the information processing apparatus generates an index 144′ corresponding to the array data 143. The index 144′ is information in which a character and an offset are associated with each other. The offset indicates a position of the corresponding character existing on the array data 143. For example, when the character “ [symbol] ” exists at the n₁-th character from a head of the array data 143, a flag “1” is set at a position of an offset n₁ in a line (bitmap) corresponding to the character “ [symbol] ” of the index 144′.

Further, the index 144′ in the embodiment also associates positions of the words “head”, “end”, and “US” with offsets. For example, a head of the word “ [symbol] ” is “ [symbol] ” and an end is “ [symbol] ”. When the head “ [symbol] ” of the word “ [symbol] [symbol] ” exists at the n₂-th character from the head of the array data 143, a flag “1” is set at a position of an offset n₂ in a line corresponding to the head of the index 144′. When the end “ [symbol] ” of the word “ [symbol] ” exists at the n₃-th character from the head of the array data 143, a flag “1” is set at a position of an offset n₃ in a line corresponding to the end of the index 144′.

Further, when “<US>” exists at the n₄-th character from the head of the array data 143, a flag “1” is set at a position of an offset n₄ in the line corresponding to <US> of the index 144′.

The information processing apparatus can grasp positions of the characters forming the word included in the character string data 142, the head, the end, and the delimiter (<US>) of the characters by referring to the index 144′. Further, it is possible to say that the character string included in the character string data 142 from the head to the end that can be determined based on the index 144′ is a word serving as a conversion candidate.

Here, it is assumed that the information processing apparatus receives “ [symbol] ”, for example, as character string data as a conversion target. Then, the information processing apparatus sets a character string from the head to the end as a unit of delimitation based on the index 144′ to extract the word serving as the conversion candidate including a head of the received conversion target character string data. In the extraction result illustrated in FIG. 1, the words “ [symbol] ”, “ [symbol] [symbol] ”, “ [symbol] ” are extracted.

As described above, the information processing apparatus generates the index 144′ relating to words (morphemes) of the dictionary data 141 based on the character string data 142 and the dictionary data 141, and sets a flag that enables the head and the end to be discriminated for each word. Then, the information processing apparatus uses the index 144′ to extract the word serving as the conversion candidate from the character string data 142.

Incidentally, the information processing apparatus is not limited to the case of kana-kanji conversion, and can generate the index 144′ relating to registered items of the dictionary data 141 based on the character string data 142 and the dictionary data 141, and sets a flag that enables the head and the end to be discriminated for each registered item even in the case of morpheme analysis. Then, the information processing apparatus can extract a dividable word from the character string data 142 by using the index 144′ to determine the longest matching character string with a character string from the head to the end as a unit of delimitation.

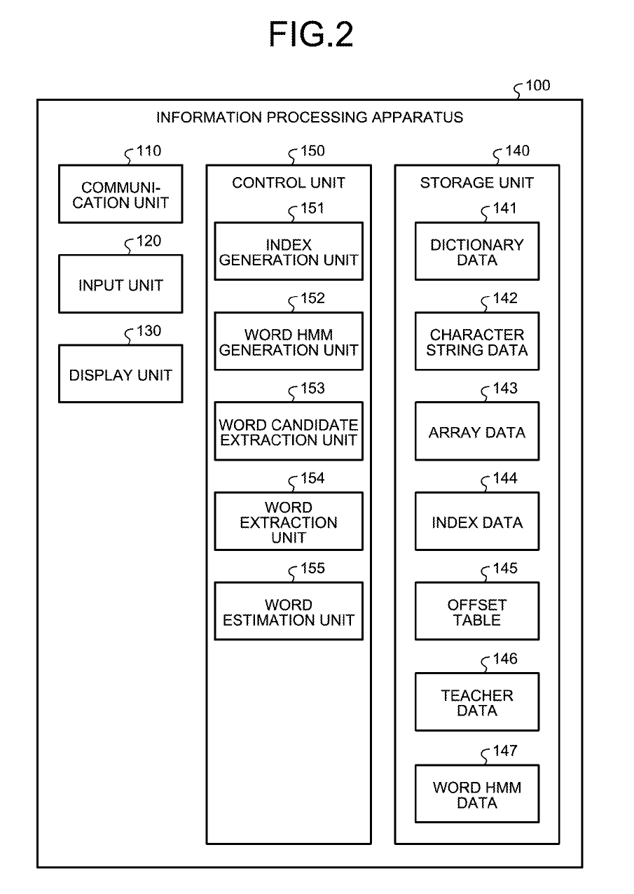

FIG. 2 is a functional block diagram illustrating a configuration of the information processing apparatus according to the embodiment. As illustrated in FIG. 2, an information processing apparatus 100 includes a communication unit 110, an input unit 120, a display unit 130, a storage unit 140, and a control unit 150.

The communication unit 110 is a processor that communicates with another external device via a network. The communication unit 110 corresponds to a communication device. For example, the communication unit 110 may receive the dictionary data 141, the character string data 142, teacher data 146, and the like from an external device and store the received data in the storage unit 140.

The input unit 120 is an input device configured to input various types of information to the information processing apparatus 100. For example, the input unit 120 corresponds to a keyboard, a mouse, a touch panel, or the like.

The display unit 130 is a display device configured to display various kinds of information output from the control unit 150. For example, the display unit 130 corresponds to a liquid crystal display or a touch panel.

The storage unit 140 has the dictionary data 141, the character string data 142, the array data 143, index data 144, an offset table 145, the teacher data 146, and word HMM data 147. The storage unit 140 corresponds to a semiconductor memory device such as a flash memory or a storage device such as a hard disk drive (HDD).

In terms of morpheme analysis, the dictionary data 141 is information defining a CJK word serving as a dividable candidate (division candidate). In terms of kana-kanji conversion, the dictionary data 141 is information defining a CJK word serving as a word candidate that can be subjected to the kana-kanji conversion. Here, the CJK word of a noun is illustrated as an example, but the dictionary data 141 includes CJK words such as adjectives, verbs, and adverbs. Further, verb conjugation is defined regarding the verb.

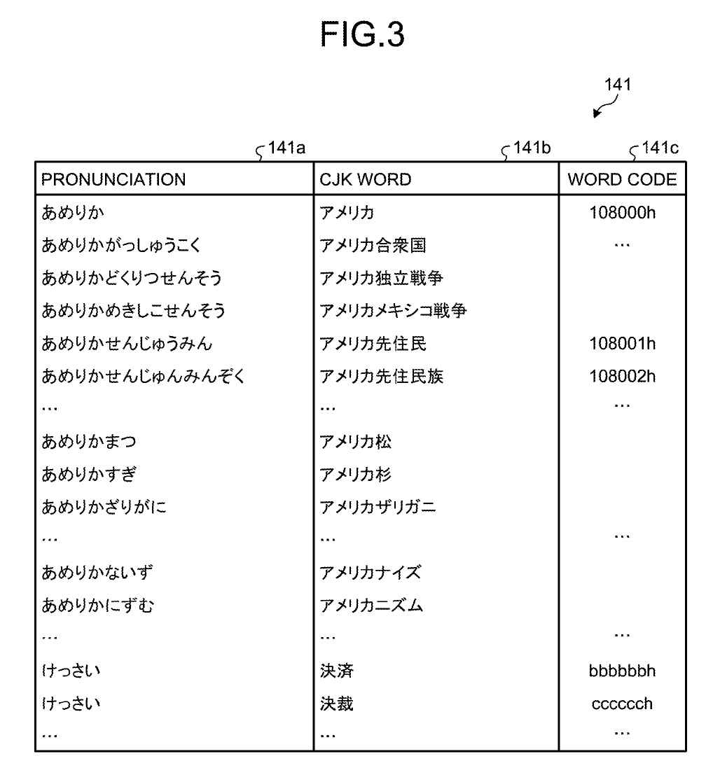

FIG. 3 is a view illustrating an example of a data structure of the dictionary data. As illustrated in FIG. 3, the dictionary data 141 stores a pronunciation 141a, a CJK word 141b, and a word code 141c in association with each other. The pronunciation 141a is a pronunciation of the CJK word 141b. Different from the character code string of the CJK word, the word code 141c is a coded code (coding code) uniquely representing the CJK word. For example, the word code 141c indicates a code that can be allocated more shortly to a CJK word having a higher appearance frequency of CJK words appearing in document data based on the teacher data 146 to be described later. The dictionary data 141 is generated in advance.

The character string data 142 is data of a document to be processed. For example, the character string data 142 is written in CJK characters. As an example, “. . . [symbol] . . . [symbol] [symbol] [symbol] . . . [symbol] . . . ” is written in the character string data 142.

Returning to FIG. 2, the array data 143 has a pronunciation of a CJK word defined in the dictionary data 141 among the character strings included in the character string data 142. Incidentally, the array data 143 has the pronunciation of the CJK word in the case of performing the kana-kanji conversion, but it is assumed that the array data 143 has two kinds of a CJK word and a pronunciation of the CJK word in the case of also performing the morpheme analysis. Hereinafter, the pronunciation of the CJK word will be simply described as a word in some cases.

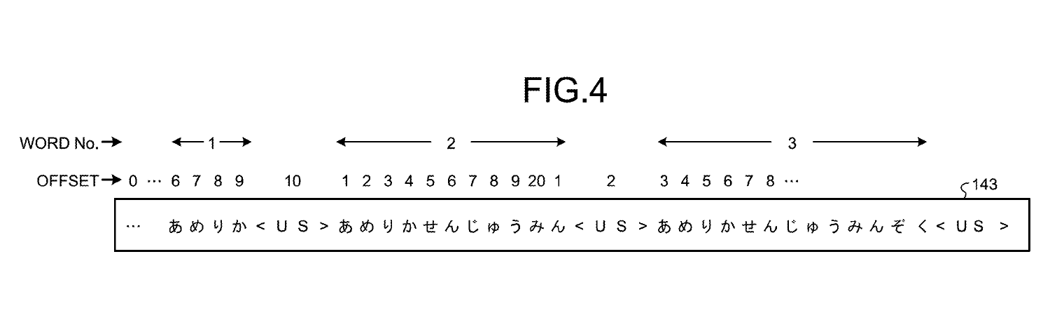

FIG. 4 is a view illustrating an example of a data structure of the array data. As illustrated in FIG. 4, a pronunciation of each CJK word is delimited by <US> in the array data 143. Incidentally, a number above the array data 143 indicates an offset from a head “0” of the array data 143. Further, a number above the offset indicates a number of a word sequentially assigned from a head word of the array data 143.

Returning to FIG. 2, the index data 144 is a hashed index 144′ as will be described later. The index 144′ is information in which a character and an offset are associated with each other. The offset indicates a position of a character existing on the array data 143. For example, when the character “ [symbol] ” exists at the n₁-th character from a head of the array data 143, a flag “1” is set at a position of an offset n₁ in a line (bitmap) corresponding to the character “ [symbol] ” of the index 144′.

Further, the index 144′ also associates positions of the words “head”, “end”, and “US” with offsets. For example, a head of the word “ [symbol] ” is “ [symbol] ” and an end is “ [symbol] ”. When the head “ [symbol] ” of the word “ [symbol] ” exists at the n₂-th character from the head of the array data 143, a flag “1” is set at a position of an offset n₂ in a line corresponding to the head of the index 144′. When the end “ [symbol] ” of the word “ [symbol] ” exists at the n₃-th character from the head of the array data 143, a flag “1” is set at a position of an offset n₃ in a line corresponding to the end of the index 144′. When “<US>” exists at the n₄-th character from the head of the array data 143, a flag “1” is set at a position of an offset n₄ in the line corresponding to <US> of the index 144′.

The index 144′ is hashed as will be described later and stored in the storage unit 140 as the index data 144. Incidentally, the index data 144 is generated by a index generation unit 151 to be described later.

Returning to FIG. 2, the offset table 145 is a table that stores an offset corresponding to a head of each word based on a bitmap at the head of the index data 144, the array data 143, and the dictionary data 141. Incidentally, the offset table 145 is generated at the time or restoring the index data 144.

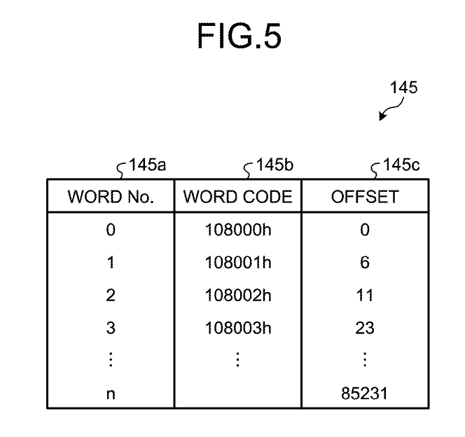

FIG. 5 is a view illustrating an example of a data structure of the offset table. As illustrated in FIG. 5, the offset table 145 stores a word No. 145a, a word code 145b, and an offset 145c in association with each other. The word No. 145a represents a number that has been assigned sequentially from a head of each word on the array data 143. Incidentally, the word No. 145a is represented by a number assigned in ascending order from “0”. The word code 145b corresponds to the word code 141c of the dictionary data 141. The offset 145c represents a position (offset) of the “head” of the word from the head of the array data 143. For example, when a word “ [symbol] ” corresponding to a word code “108001h” exists as the first word from the head in the array data 143, “1” is set as the word No. When a head “ [symbol] ” of the word “ [symbol] ” corresponding to the word code “108001h” is positioned as the sixth character from the head of the array data 143, “6” is set as the offset.

Returning to FIG. 2, the teacher data 146 is data indicating a large quantity of natural sentences including homonyms for accuracy improvement of kana-kanji conversion. For example, the teacher data 146 may be data of a large quantity of natural sentences such as corpuses.

The word HMM data 147 is data including a word code identifying each CJK word registered in the dictionary data 141 and co-occurrence information of CJK words included in the teacher data 146 for each CJK word. The co-occurrence information includes a co-occurring word and a co-occurrence rate, for example. The word HMM data 147 is used in the kana-kanji conversion when extracting a word serving as a conversion candidate from received character or character string. The word HMM data 147 is also used in text analysis of the morpheme analysis when extracting any word from a plurality of dividable word candidates. Incidentally, an example of a data structure of the word HMM data 147 will be described later.

Returning to FIG. 2, the control unit 150 includes an index generation unit 151, a word HMM generation unit 152, a word candidate extraction unit 153, a word extraction unit 154, and a word estimation unit 155. The control unit 150 can be realized by a central processing unit (CPU), a micro processing unit (MPU), or the like. Further, the control unit 150 can be also realized by a hard-wire logic such as an application specific integrated circuit (ASIC), a field programmable gate array (FPGA), or the like.

The index generation unit 151 generates the index data 144 indicating relative positions of the respective characters of each character included in the word registered in the dictionary data 141, a head character of the word, an end character of the word based on the dictionary data 141 used for morpheme analysis.

For example, the index generation unit 151 compares data of pronunciations of the character string data 142 with the dictionary data 141. The index generation unit 151 scans the data of pronunciations of the character string data 142 from the head, and extracts a character string hit with the pronunciation 141a of the CJK word 141b registered in the dictionary data 141. The index generation unit 151 stores the hit character string in the array data 143. When storing the next hit character string in the array data 143, the index generation unit 151 sets <US> next to the preceding character string, and then, stores the next hit character string next to the set <US>. The index generation unit 151 repeatedly executes the above processing to generate array data 143.

Further, the index generation unit 151 generates the index 144′ after generating the array data 143. The index generation unit 151 scans the array data 143 from the head and associates CJK characters and offsets, a head of a CJK character string and an offset, an end of the CJK character string and an offset, and <US> and an offset with each other to generate the index 144′.

Further, the index generation unit 151 associates the head of the CJK character string with the word No. to generate an upper index at the head of the CJK character string. As a result, the index generation unit 151 generates the upper index corresponding to the granularity of the word No. or the like, and can speed up narrowing-down of extraction areas when extracting a keyword thereafter.

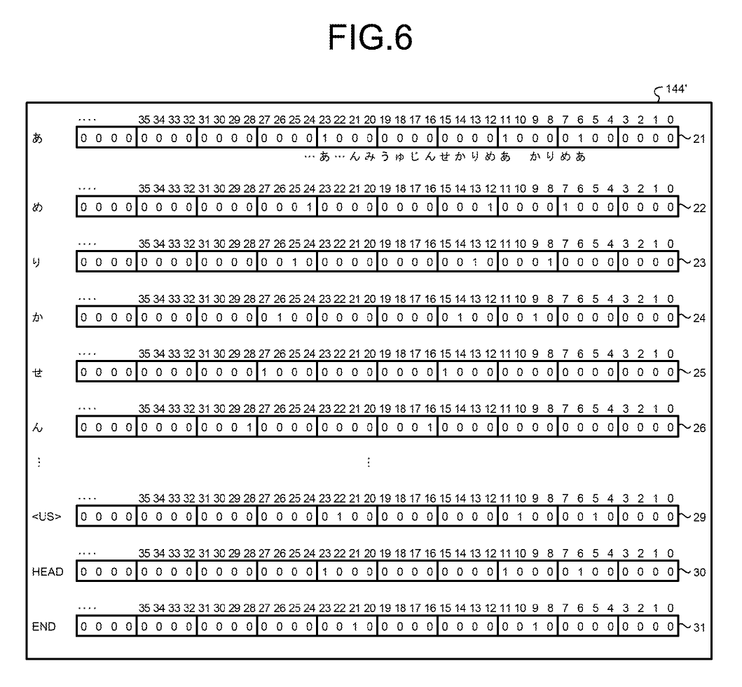

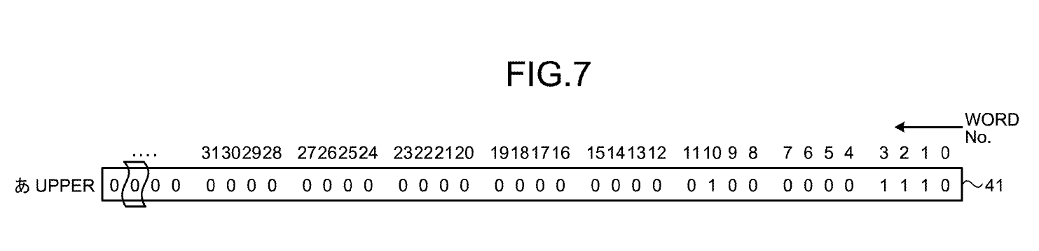

FIG. 6 is a view illustrating an example of a data structure of the index. FIG. 7 is a view illustrating an example of a data structure of the upper index. As illustrated in FIG. 6, the index 144′ has bitmaps 21 to 31 corresponding to the respective CJK characters, <US>, the head, and the end.

For example, bitmaps corresponding to the CJK characters “ [symbol] ”, “ [symbol] ”, “ [symbol] ”, “ [symbol] ”, “ [symbol] ”, “ [symbol] ”, . . . in the array data 143 “ [symbol] <US> [symbol] [symbol] <US> [symbol] . . . ” are set as the bitmaps 21 to 26, respectively. FIG. 6 does not illustrate bitmaps corresponding to other CJK characters.

A bitmap corresponding to <US> is set as the bitmap 29. A bitmap corresponding to the “head” of the character is set as the bitmap 30. The bitmap corresponding to the “end” of the character is set as the bitmap 31.

For example, the CJK character “ [symbol] ” exists at offsets “6, 11, 23” of the array data 143 in the array data 143 illustrated in FIG. 4. Thus, the index generation unit 151 sets a flag “1” to the offsets “6, 11, 23” of the bitmap 21 of the index 144′ illustrated in FIG. 6. Similarly, the array data 143 sets flags for other CJK characters and <US>.

In the array data 143 illustrated in FIG. 4, the head of each CJK word exists at the offsets “6, 11, 23” of the array data 143. Thus, the index generation unit 151 sets a flag “1” to the offsets “6, 11, 23” of the bitmap 30 of the index 144′ illustrated in FIG. 6.

In the array data 143 illustrated in FIG. 4, the end of each CJK word exists at offsets “9, 21, . . . ” of the array data 143. Thus, the index generation unit 151 sets a flag “1” to the offsets “9, 21, . . . ” of the bitmap 31 of the index 144′ illustrated in FIG. 6.

As illustrated in FIG. 7, the index 144′ has an upper bitmap corresponding to a head of a CJK character string. An upper bitmap corresponding to “ [symbol] ” is set as an upper bitmap 41. In the array data 143 illustrated in FIG. 4, the head “ [symbol] ” of each CJK word exists in word Nos. “1, 2, 3” of the array data 143. Thus, the index generation unit 151 sets a flag “1” to the word Nos. “1, 2, 3” of the upper bitmap 41 of the index 144′ illustrated in FIG. 7.

When generating the index 144′, the index generation unit 151 generates the index data 144 by hashing the index 144′ in order to reduce the data amount of the index 144′.

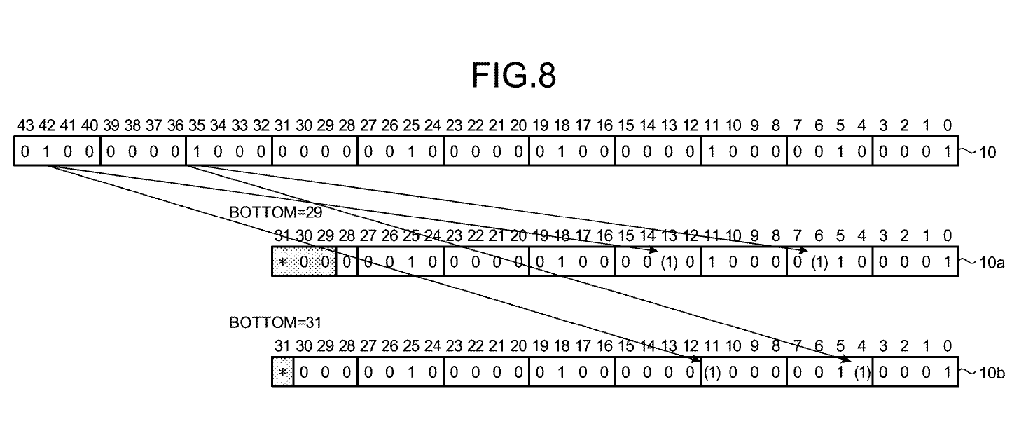

FIG. 8 is a view for describing hashing of the index. Here, it is assumed that a bitmap 10 is included in an index as an example, and a case where the bitmap 10 is hashed will be described.

For example, the index generation unit 151 generates a bitmap 10a of a bottom 29 and a bitmap 10b of a bottom 31 from the bitmap 10. In the bitmap 10a, a delimiter is set for each offset 29 with respect to the bitmap 10, and offsets with a flag “1” having the set delimiter as a head are expressed by flags of offsets 0 to 28 of the bitmap 10a.

The index generation unit 151 copies information of the offsets 0 to 28 of the bitmap 10 to the bitmap 10a. The index generation unit 151 processes the information of the offset 29 and the subsequent offsets of the bitmap 10a as follows.

A flag “1” is set to an offset “35” of the bitmap 10. Since the offset “35” is the offset “29+6”, the index generation unit 151 sets a flag “(1)” to the offset “6” of the bitmap 10a. Incidentally, the first offset is set to zero. A flag “1” is set to an offset “42” of the bitmap 10. Since the offset “42” is the offset “29+13”, the index generation unit 151 sets a flag “(1)” to the offset “13” of the bitmap 10a.

In the bitmap 10b, a delimiter is set for each offset 31 with respect to the bitmap 10, and offsets with a flag “1” having the set delimiter as a head are expressed by flags of offsets 0 to 30 of the bitmap 10b.

A flag “1” is set to an offset “35” of the bitmap 10. Since the offset “35” is the offset “31+4”, the index generation unit 151 sets a flag “(1)” to the offset “4” of the bitmap 10b. Incidentally, the first offset is set to zero. A flag “1” is set to an offset “42” of the bitmap 10. Since the offset “42” is the offset “31+11”, the index generation unit 151 sets a flag “(1)” to the offset “11” of the bitmap 10a.

The index generation unit 151 generates the bitmaps 10a and 10b from the bitmap 10 by executing the above processing. The bitmaps 10a and 10b are results obtained by hashing the bitmap 10.

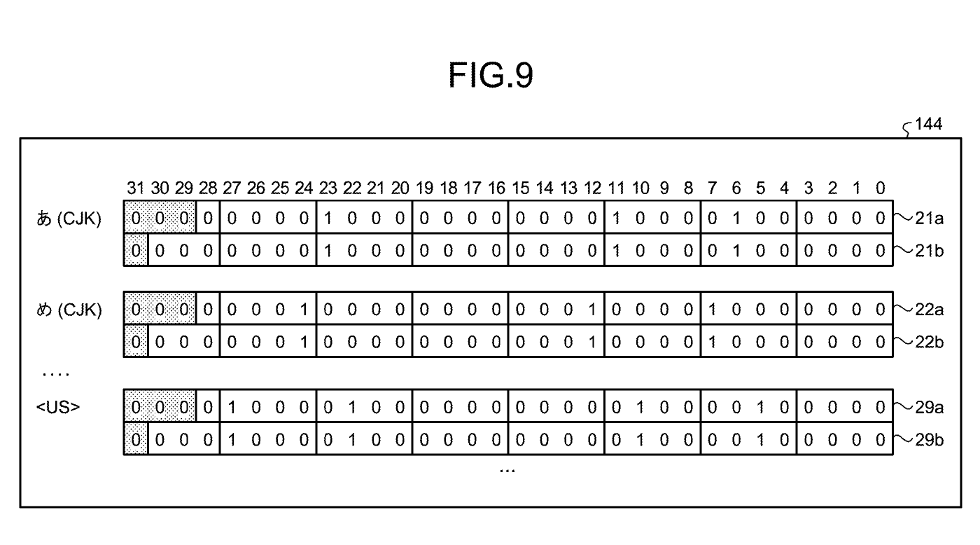

The index generation unit 151 performs the hashing on bitmaps 21 to 31 illustrated in FIG. 6 to generate the hashed index data 144. FIG. 9 is a view illustrating an example of a data structure of the index data. For example, when hashing is performed on the bitmap 21 of the index 144′ before the hashing illustrated in FIG. 6, a bitmap 21a and a bitmap 21b illustrated in FIG. 9 are generated. When hashing is performed on the bitmap 22 of the hashed index 144′ illustrated in FIG. 6, a bitmap 22a and a bitmap 22b illustrated in FIG. 9 are generated. When hashing is performed on the bitmap 29 of the hashed index 144′ illustrated in FIG. 6, a bitmap 29a and a bitmap 29b illustrated in FIG. 9 are generated. Illustrations relating to other hashed bitmaps are omitted in FIG. 9.

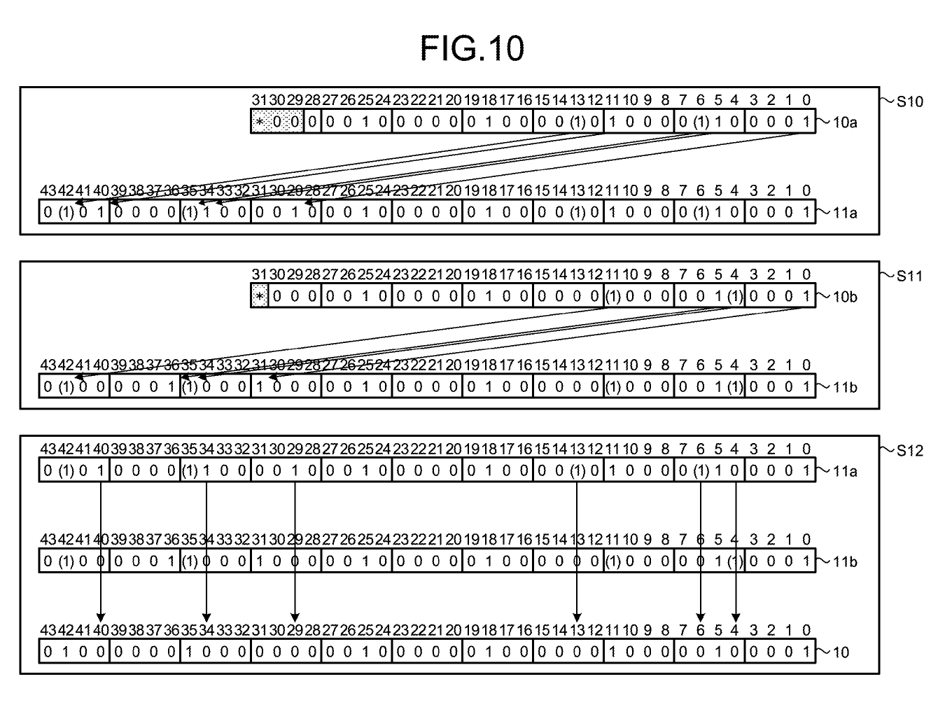

Here, a process of restoring a hashed bitmap will be described. FIG. 10 is a view for describing an example of the process of restoring the hashed index. Here, a process of restoring the bitmap 10 based on the bitmap 10a and the bitmap 10b will be described as an example. The bitmaps 10, 10a, and 10b correspond to those described with reference to FIG. 8.

A process of Step S10 will be described. The restoration process generates a bitmap 11a based on the bitmap 10a with the bottom 29. Flag information of offsets 0 to 28 of the bitmap 11a is the same as the flag information of the offsets 0 to 28 of the bitmap 10a. Flag information of offset 29 and the subsequent offsets of the bitmap 11a is a repetition of the flag information of the offsets 0 to 28 of the bitmap 10a.

A process of Step S11 will be described. The restoration process generates a bitmap 11b based on the bitmap 10b with the bottom 31. Flag information of offsets 0 to 30 of the bitmap 11b is the same as the flag information of the offsets 0 to 30 of the bitmap 10b. Flag information of offset 31 and the subsequent offsets of the bitmap 11b is a repetition of the flag information of the offsets 0 to 30 of the bitmap 10b.

A process of Step S12 will be described. In the restoration process, an AND operation between the bitmap 11a and the bitmap 11b is executed to generate the bitmap 10. In the example illustrated in FIG. 10, flags of the bitmap 11a and the bitmap 11b are “1” in offsets “0, 5, 11, 18, 25, 35, 42”. Thus, flags of offsets “0, 5, 11, 18, 25, 35, 42” of the bitmap 10 become “1”. The bitmap 10 is a restored bitmap. The restoration process restores each bitmap by repeatedly executing the same processing for other bitmaps to generate the index 144′.

Returning to FIG. 2, the word HMM generation unit 152 generates the word HMM data 147 based on the dictionary data 141 used for the morpheme analysis and the teacher data 146.

For example, the word HMM generation unit 152 codes each CJK word included in the teacher data 146 based on the dictionary data 141. The word HMM generation unit 152 sequentially selects CJK words from the plurality of CJK words included in the teacher data 146. The word HMM generation unit 152 calculates co-occurrence rates of other CJK words included in the teacher data 146 for the selected CJK word. Then, the word HMM generation unit 152 stores a word code of the selected CJK word, and word codes and the co-occurrence rates of the other CJK words in the word HMM data 147 in association with each other. The word HMM generation unit 152 repeatedly executes the above processing to generate word HMM data 147.

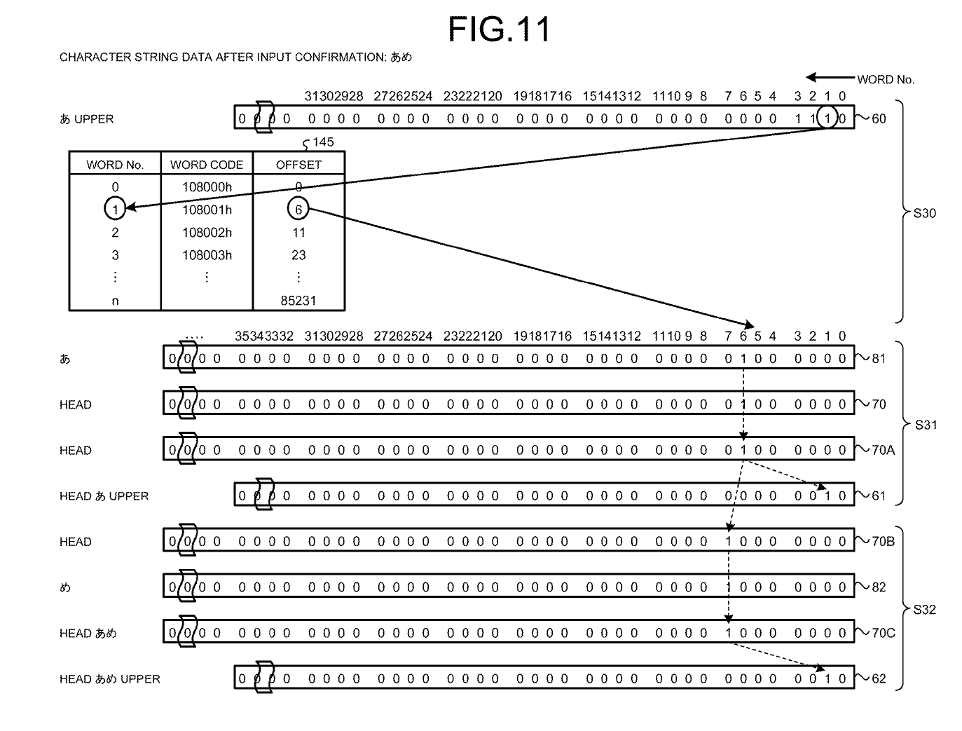

In the case of kana-kanji conversion, the word candidate extraction unit 153 is a processor that generates the index 144′ based on the index data 144 and extracts a word candidate based on the index 144′. FIG. 11 is a view for describing an example of a process of extracting the word candidate. In the example illustrated in FIG. 11, it is assumed that character string data newly received after receiving an operation indicating confirmation of input of a character or a character string is “ [symbol] ”. Then, the word candidate extraction unit 153 reads an upper bitmap of the corresponding character and a lower bitmap from the index data 144 sequentially from the first character of the corresponding character string data and executes the following processing.

First, the word candidate extraction unit 153 reads a head bitmap from the index data 144 and restores the read bitmap. Since such a restoration process has been described with reference to FIG. 10, the description thereof will be omitted. The word candidate extraction unit 153 generates the offset table 145 using the restored head bitmap, the array data 143, and the dictionary data 141. For example, an offset where “1” is set in the restored top bitmap is identified. As an example, when “1” is set at an offset “6”, the word candidate extraction unit 153 refers to the array data 143 to identify a CJK word and a word No. of the offset “6” and extracts a word code of the identified CJK word by referring to the dictionary data 141. Then, the word candidate extraction unit 153 adds the word No., the word code, and the offset to the offset table 145 in association with each other. The word candidate extraction unit 153 generates the offset table 145 by repeatedly executing the above processing.

Step S30 will be described. The word candidate extraction unit 153 reads the upper bitmap of the first character “ [symbol] ” of the character string data from the index data 144, and sets a result of restoring the read upper bitmap as an upper bitmap 60. Since such a restoration process has been described with reference to FIG. 10, the description thereof will be omitted. The word candidate extraction unit 153 identifies a word No. in which a flag “1” is set in the upper bitmap 60, and refers to the offset table 145 to identify an offset of the identified word No. It is indicated in the upper bitmap 60 that the flag “1” is set in the word No. “1” and the offset of the word No. “1” is “6”.

Step S31 will be described. The word candidate extraction unit 153 reads the bitmap of the first character “ [symbol] ” of the character string data and the head bitmap from the index data 144. The word candidate extraction unit 153 restores an area near the offset “6” with respect to the bitmap of the read character “ [symbol] ”, and sets the restored result as a bitmap 81. The word candidate extraction unit 153 restores an area near the offset “6” with respect to the read head bitmap, and sets the restored result as a bitmap 70. As an example, only an area of bits “0” to “29” at the bottom including the offset “6” is restored.

The word candidate extraction unit 153 identifies a head position of a character by executing an AND operation between the bitmap 81 of the character “ [symbol] ” and the bitmap 70 of the head. A result of the AND operation of the bitmap 81 of the character “ [symbol] ” and the bitmap 70 of the head is set as a bitmap 70A. It is indicated in the bitmap 70A that a flag “1” is set at an offset “6” and the offset “6” is the head of the CJK word.

The word candidate extraction unit 153 corrects an upper bitmap 61 with respect to the head and the character “ [symbol] ”. In the upper bitmap 61, the result of the AND operation of the bitmap 81 of the character “ [symbol] ” and the bitmap 70 of the head is “1”, the flag “1” is set in the word No. “1”.

Step S32 will be described. The word candidate extraction unit 153 shifts the first bitmap 70A to the left by one to generate a bitmap 70B. The word candidate extraction unit 153 reads a bitmap of the second character “ [symbol] ” of the character string data from the index data 144. The word candidate extraction unit 153 restores an area near the offset “6” with respect to the bitmap of the read character “ [symbol] ”, and sets the restored result as a bitmap 82.

The word candidate extraction unit 153 executes an AND operation between the bitmap 82 of the character “ [symbol] ” and the bitmap 70B of the head to determine whether “ [symbol] ” exists from the head in the word No. “1”. A result of the AND operation of the bitmap 82 of the character “ [symbol] ” and the bitmap 70B of the head is set as a bitmap 70C. It is indicated in the bitmap 70C that a flag “1” is set at an offset “7” and the character string “ [symbol] ” exists from the head in the word No. “1”.

The word candidate extraction unit 153 corrects an upper bitmap 62 with respect to the head and the character string “ [symbol] ”. In the upper bitmap 62, the result of the AND operation of the bitmap 82 of the character “ [symbol] ” and the bitmap 70B of the head is “1”, the flag “1” is set in the word No. “1”. That is, it can be understood that the character string data “ [symbol] ” after the input confirmation exists at the head of the word indicated by the word No. “1”.

The word candidate extraction unit 153 repeatedly executes the above processing for the other word Nos. where the flag “1” is set from the upper bitmap 60 of the first character “ [symbol] ” of the character string data to generate the upper bitmap 62 for the head and the character string “ [symbol] ”. That is, as the upper bitmap 62 is generated, it is possible to know any head of a word where the character string data “ [symbol] ” after the input confirmation exists. That is, the word candidate extraction unit 153 extracts a word candidate having the character string data “ [symbol] ” after the input confirmation at the head.

Returning to FIG. 2, the word estimation unit 155 estimates a word serving as a candidate for kana-kanji conversion from the extracted word candidates based on the word HMM data 147. Incidentally, the word HMM data 147 is generated by the word HMM generation unit 152 to be described later.

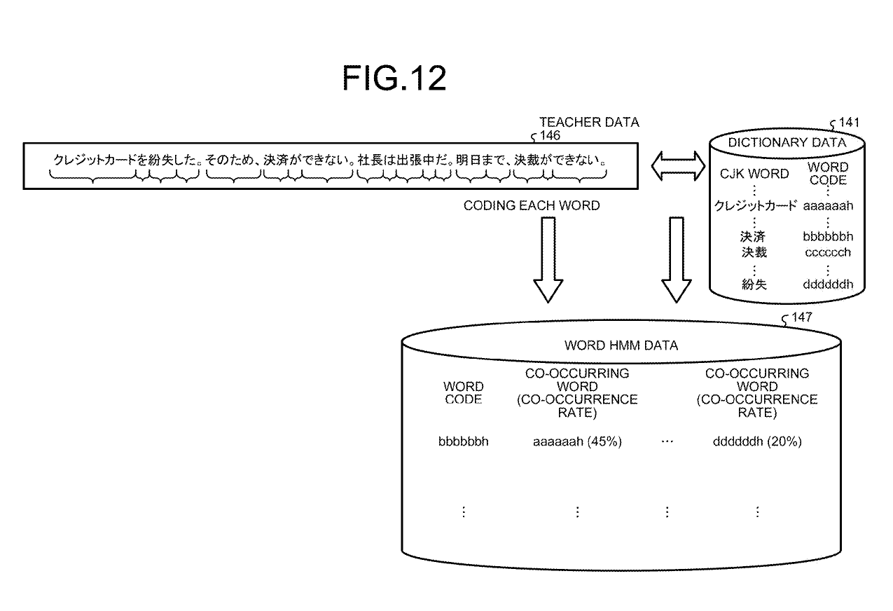

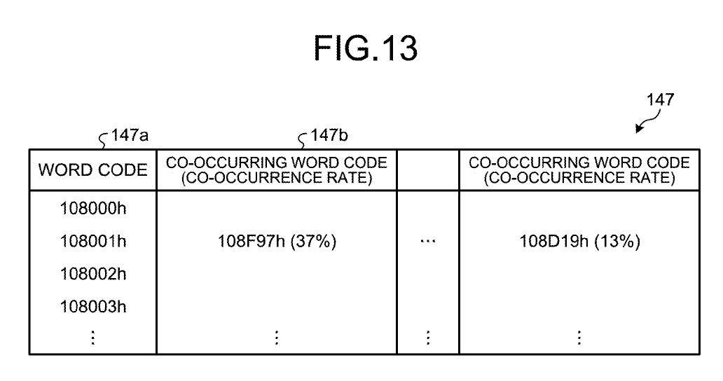

Here, an example of a generation process and an example of a data structure of the word HMM data 147 will be described with reference to FIGS. 12 and 13. FIG. 12 is a diagram for describing an example of the word HMM generation process.

As illustrated in FIG. 12, the word HMM generation unit 152 codes each word included in the teacher data 146 based on the dictionary data 141. Incidentally, the teacher data 146 includes, for example, “ [symbol] ” and “ [symbol] ” as homonyms. The teacher data 146 includes “ [symbol] [symbol] [symbol] [symbol] ” and “ [symbol] [symbol] [symbol] ” as natural sentences including these homonyms. The dictionary data 141 is the same as the dictionary data used for the morpheme analysis. The dictionary data 141 stores a CJK word and a word code obtained by coding the word in association with each other.

The word HMM generation unit 152 calculates co-occurrence rates of other words included in the teacher data 146 for each word included in the teacher data 146. That is, the word HMM generation unit 152 calculates the co-occurrence rate at which the word included in the teacher data 146 and another word included in the teacher data 146 simultaneously appear.

The word HMM generation unit 152 generates the word HMM data 147 including the word code of each word, and the word codes and the co-occurrence rates of the other words.

As a result, the word HMM generation unit 152 generates co-occurrence information for each word code, and thus, extracts a word serving as a conversion candidate in accordance with co-occurrence states of other words indicated by the word codes from the word candidates indicated by the word codes so that it is possible to reduce extraction cost of the word. That is, since the word HMM generation unit 152 generates the co-occurrence information for each word code, it is possible to reduce extraction cost of the word serving as the conversion candidate in the kana-kanji conversion. Further, a conventional word HMM is composed of variable-length character strings, and thus, is large in size, but the word HMM data 147 is composed of word codes instead of variable-length character strings so that reduction in size can be achieved.

FIG. 13 is a view illustrating an example of a data structure of the word HMM data. As illustrated in FIG. 13, the word HMM data 147 stores a word code 147a and a co-occurring word code 147b in association with each other. The word code 147a corresponds to the word code 141c of the dictionary data 141. The co-occurring word code 147b represents a word code corresponding to a word co-occurring with a word indicated by the word code 147a. Incidentally, a number in parentheses indicates a co-occurrence rate. As an example, a word of “108001h” illustrated as the word code 147a co-occurs with a word of “108F97h” illustrated as the co-occurring word code 147b in the teacher data 146 at a probability of 37%. The word of “108001h” illustrated as the word code 147a co-occurs with a word of “108D19h” illustrated as the co-occurring word code 147b in the teacher data 146 at a probability of 13%.

Returning to FIG. 2, for example, the word estimation unit 155 acquires co-occurrences rates of co-occurring words for a plurality of word candidates extracted by the word candidate extraction unit 153, based on the word HMM data 147. The word estimation unit 155 calculates a score for each combination of the respective co-occurring words based on the co-occurrence rate of each co-occurring word. Then, the word estimation unit 155 outputs a word as a candidate for kana-kanji conversion in order from a combination having a higher score value. A combination having a higher score is set as a candidate for kana-kanji conversion with a higher priority. That is, the word estimation unit 155 estimates the word serving as the candidate for kana-kanji conversion.

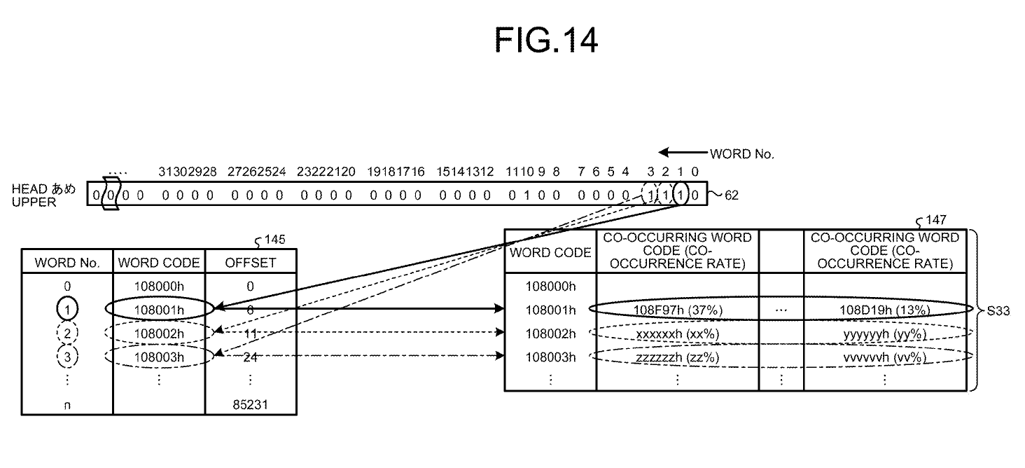

FIG. 14 is a view for describing an example of a process of estimating a word. In the example illustrated in FIG. 14, it is assumed that the word candidate extraction unit 153 has generated the upper bitmap 62 for the head and the character string “ [symbol] ” as described in S32 of FIG. 11.

Step S33 illustrated in FIG. 14 will be described. The word estimation unit 155 identifies a word No. in which “1” is established in the upper bitmap 62 for the head and the character string “ [symbol] ”. The word estimation unit 155 refers to the offset table 145 to identify a word code corresponding to the identified word No. Here, “108001h” of a word No. “1” is identified as the word code of the CJK word including “ [symbol] ”. “108002h” of a word No. “2” is identified. “108003h” of a word No. “3” is identified.

The word estimation unit 155 refers to the word HMM data 147 to acquire co-occurrence information of other co-occurring words with respect to the identified word code. The co-occurrence information includes, for example, a word code and a co-occurrence rate of the co-occurring word. Here, the word estimation unit 155 acquires co-occurrence information (“108F97h”, (37%)), . . . (“108D19h”, (13%)) of other co-occurring words with respect to the identified word code “108001h”. The word estimation unit 155 acquires co-occurrence information (“xxxxxxh”, (xx %)), . . . (“yyyyyyh”, (yy %)) of other co-occurring words with respect to the identified word code “108002h”. The word estimation unit 155 acquires co-occurrence information (“zzzzzzh”, (zz %)), . . . (“vvvvvvh”, (vv %)) of other co-occurring words with respect to the identified word code “108003h”.

The word estimation unit 155 calculates a score for each combination of co-occurring words based on the co-occurrence information with respect to the identified word code. For example, the word estimation unit 155 acquires corresponding co-occurring word code and co-occurrence rate for each identified word code. The word estimation unit 155 calculates the score using a co-occurrence rate of a co-occurring word included in (or including) a character or a character string whose input has been confirmed among the co-occurring words indicated by the corresponding co-occurring word code for each identified word code.

The word estimation unit 155 estimates a CJK word indicated by the word code for the combination as a candidate for kana-kanji conversion in order from a combination having a higher score value and outputs the estimated word. That is, the word estimation unit 155 estimates the CJK word serving as the candidate for kana-kanji conversion corresponding to a character or a character string whose input has been confirmed and a character or a character string that has been newly received.

As a result, the word estimation unit 155 can efficiently access the word HMM dependent on the word code in the score calculation of the word HMM in the kana-kanji conversion by using the word code. In other words, the word estimation unit 155 can reduce cost for extraction of the word in accordance with co-occurrence states of other words from among the identified words in the score calculation of the word HMM in the kana-kanji conversion by using the word code.

Returning to FIG. 2, the word extraction unit 154 is a processor that generates the index 144′ based on the index data 144 and extracts a plurality of divisible CJK words based on the index 144′ in the case of morpheme analysis. Incidentally, an example of the process of generating the index 144′ based on the index data 144 performed by the word extraction unit 154 has been described with reference to FIG. 10, and the description thereof will be omitted.

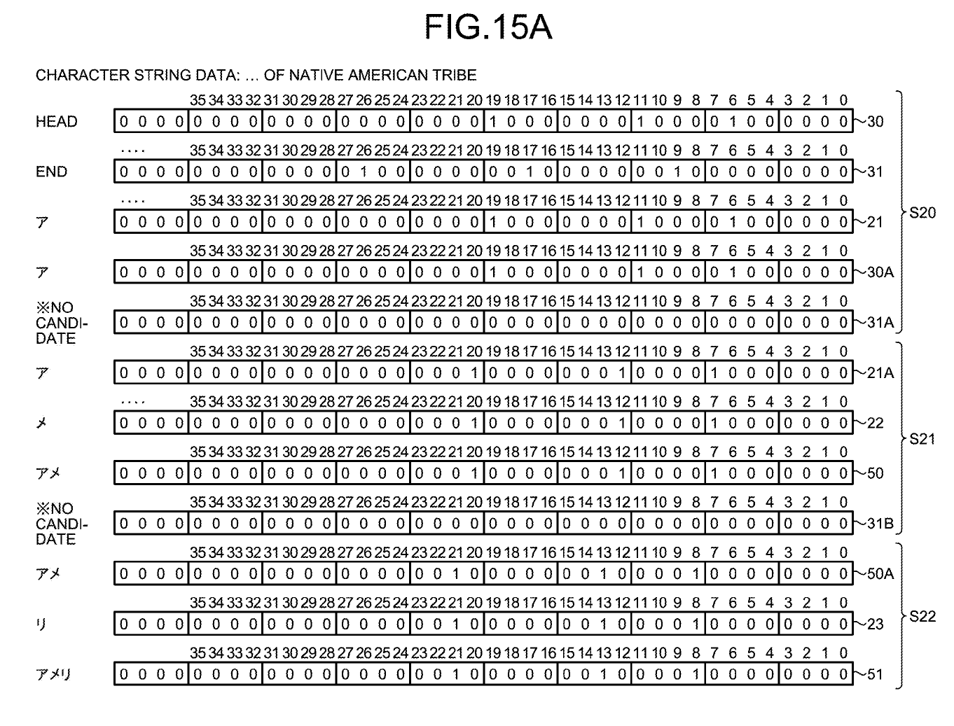

After generating the index 144′, the word extraction unit 154 extracts the dividable CJK words based on the index 144′. FIGS. 15A and 15B are views for describing an example of the process of extracting the CJK words. In the example illustrated in FIGS. 15A and 15B, the character string data 142 includes “ [symbol] . . . ”, and a bitmap of the corresponding character is read from the index 144′ in order from the first character of the character string data 142 to execute the following processing.

Step S20 will be described. From the index 144′, the word extraction unit 154 reads a bitmap 30 of the head, a bitmap 31 of the end, and a bitmap 21 of the character “ [symbol] ”. The word extraction unit 154 identifies a head position of a character by executing an AND operation of the head bitmap 30 and the bitmap 21 of the character “ [symbol] ”. The result of the AND operation of the head bitmap 30 and the bitmap 21 of the character “ [symbol] ” is set as a bitmap 30A. It is indicated in the bitmap 30A that a flag “1” is set at offsets “6, 11, 19” and the offsets “6, 11, 19” are heads of the CJK words.

The word extraction unit 154 identifies an end position of a character by executing an AND operation of the end bitmap 31 and the bitmap 21 of the character “ [symbol] ”. The result of the AND operation of the end bitmap 31 and the bitmap 21 of the character “ [symbol] ” is set as a bitmap 31A. It is indicated in the bitmap 31A that there is no end candidate in “ [symbol] ” since the flag “1” is not set.

Step S21 will be described. The word extraction unit 154 shifts the bitmap 21 of the character “ [symbol] ” to the left by one to generate a bitmap 21A. The word extraction unit 154 reads a bitmap 22 of a character “ [symbol] ” from the index 144′. The word extraction unit 154 executes an AND operation between the bitmap 21A and the bitmap 22 to generate a bitmap 50 corresponding to the character string “ [symbol] ”.

The word extraction unit 154 identifies an end position of a character by executing an AND operation of the end bitmap 31 and the bitmap 50 of the character string “ [symbol] ”. The result of the AND operation of the end bitmap 31 and the bitmap 50 of the character string “ [symbol] ” is set as a bitmap 31B. It is indicated in the bitmap 31B that there is no end candidate in the character string “ [symbol] ” since the flag “1” is not set.

Step S22 will be described. The word extraction unit 154 shifts the bitmap 50 of the character string “ [symbol] ” to the left by one to generate a bitmap 50A. The word extraction unit 154 reads a bitmap 23 of a character “ [symbol] ” from the index 144′. The word extraction unit 154 generates a bitmap 51 corresponding to the character string “ [symbol] ” by executing an AND operation between the bitmap 50A and the bitmap 23.

The word extraction unit 154 identifies an end position of a character by executing an AND operation of the end bitmap 31 and the bitmap 51 of the character string “ [symbol] ”. The result of the AND operation of the end bitmap 31 and the bitmap 51 of the character string “ [symbol] ” is set as a bitmap 31C. It is indicated in the bitmap 31C that there is no end candidate in the character string “ [symbol] ” since the flag “1” is not set.

Step S23 will be described. The word extraction unit 154 shifts the bitmap 51 of the character string “ [symbol] [symbol] ” to the left by one to generate a bitmap 51A. The word extraction unit 154 reads a bitmap 24 of a character “ [symbol] ” from the index 144′. The word extraction unit 154 generates a bitmap 52 corresponding to the character string “ [symbol] ” by executing an AND operation between the bitmap 51A and the bitmap 24.

The word extraction unit 154 identifies an end position of a character by executing an AND operation of the end bitmap 31 and the bitmap 52 of the character string “ [symbol] ”. The result of the AND operation of the end bitmap 31 and the bitmap 52 of the character string “ [symbol] [symbol] ” is set as a bitmap 31D. It is indicated in the bitmap 31D that there is an end candidate “ [symbol] ” in the character string “ [symbol] ” since the flag “1” is set. The word extraction unit 154 extracts the character string “ [symbol] ” from the head character “ [symbol] ” identified in Step S20 to the end character “ [symbol] ” determined in Step S23 as a CJK word serving as a division candidate.

Step S24 will be described. The word extraction unit 154 shifts the bitmap 52 of the character string “ [symbol] [symbol] ” to the left by one to generate a bitmap 52A. The word extraction unit 154 reads a bitmap 25 of a character “ [symbol] ” from the index 144′. The word extraction unit 154 generates a bitmap 53 corresponding to the character string “ [symbol] ” by executing an AND operation between the bitmap 52A and the bitmap 25.

The word extraction unit 154 identifies an end position of a character by executing an AND operation of the end bitmap 31 and the bitmap 53 of the character string “ [symbol] ”. The result of the AND operation of the end bitmap 31 and the bitmap 53 of the character string “ [symbol] [symbol] ” is set as a bitmap 31E. It is indicated in the bitmap 31E that there is no end candidate in the character string “ [symbol] ” since the flag “1” is not set.

Step S25 will be described. The word extraction unit 154 shifts the bitmap 53 of the character string “ [symbol] [symbol] ” to the left by one to generate a bitmap 53A. The word extraction unit 154 reads a bitmap 26 of a character “ [symbol] ” from the index 144′. The word extraction unit 154 generates a bitmap 54 corresponding to the character string “ [symbol] ” by executing an AND operation between the bitmap 53A and the bitmap 26.

The word extraction unit 154 identifies an end position of a character by executing an AND operation of the end bitmap 31 and the bitmap 54 of the character string “ [symbol] ”. The result of the AND operation of the end bitmap 31 and the bitmap 54 of the character string “ [symbol] [symbol] ” is set as a bitmap 31F. It is indicated in the bitmap 31F that there is no end candidate in the character string “ [symbol] ” since the flag “1” is not set.

Step S26 will be described. The word extraction unit 154 shifts the bitmap 54 of the character string “ [symbol] [symbol] ” to the left by one to generate a bitmap 54A. The word extraction unit 154 reads a bitmap 27 of a character “ [symbol] ” from the index 144′. The word extraction unit 154 generates a bitmap 55 corresponding to the character string “ [symbol] ” by executing an AND operation between the bitmap 54A and the bitmap 27.

The word extraction unit 154 identifies an end position of a character by executing an AND operation of the end bitmap 31 and the bitmap 55 of the character string “ [symbol] ”. The result of the AND operation of the end bitmap 31 and the bitmap 55 of the character string “ [symbol] [symbol] ” is set as a bitmap 31G. It is indicated in the bitmap 31G that there is an end candidate “ [symbol] ” in the character string “ [symbol] ” since the flag “1” is set. The word extraction unit 154 extracts the character string “ [symbol] ” from the head character “ [symbol] ” identified in Step S20 to the end character “ [symbol] ” determined in Step S26 as a CJK word serving as a division candidate.

Step S27 will be described. The word extraction unit 154 shifts the bitmap 55 of the character string “ [symbol] [symbol] ” to the left by one to generate a bitmap 55A. The word extraction unit 154 reads a bitmap 28 of a character “ [symbol] ” from the index 144′. The word extraction unit 154 generates a bitmap 56 corresponding to the character string “ [symbol] ” by executing an AND operation between the bitmap 55A and the bitmap 28.

The word extraction unit 154 identifies an end position of a character by executing an AND operation of the end bitmap 31 and the bitmap 56 of the character string “ [symbol] ”. The result of the AND operation of the end bitmap 31 and the bitmap 56 of the character string “ [symbol] [symbol] ” is set as a bitmap 31H. It is indicated in the bitmap 31H that there is an end candidate “ [symbol] ” in the character string “ [symbol] ” since the flag “1” is set. The word extraction unit 154 extracts the character string “ [symbol] ” from the head character “ [symbol] ” identified in Step S20 to the end character “ [symbol] ” determined in Step S27 as a CJK word serving as a division candidate.

The word extraction unit 154 shifts the bitmap 56 of the character string “ [symbol] ” to the left by one to generate a bitmap 56A. The word extraction unit 154 generates a bitmap 29 in which all the flags are “0” since a bitmap corresponding to the character string “ [symbol] ” does not exist in the index 144′. In this case, the word extraction unit 154 sets the preceding bitmap 56 as a bitmap of “ [symbol] ”.

By executing the processing from Step S20 to Step S27, the word extraction unit 154 extracts the dividable CJK words “ [symbol] ”, “ [symbol] ” and “ [symbol] ” included in the character string data 142. The word extraction unit 154 stores information of the respective extracted CJK words in the storage unit 140 as an extraction result.

Thereafter, the word estimation unit 155 refers to the dictionary data 141 to identify a word code corresponding to the extracted CJK word. The word estimation unit 155 refers to the word HMM data 147 to acquire co-occurrence information of other co-occurring words with respect to the identified word code. The co-occurrence information includes, for example, a word code and a co-occurrence rate of the co-occurring word. The word estimation unit 155 calculates a score on each combination of co-occurring words based on the co-occurrence information for the identified word code and estimates and outputs the CJK word indicated by the word code for the combination as a division candidate in order from a combination having a higher score value. That is, the word estimation unit 155 estimate the CJK word as the division word candidate from the character string data.

As a result, the word extraction unit 154 can efficiently access the word HMM dependent on the word code in the score calculation of the word HMM in the text analysis of the morpheme analysis by using the word code.

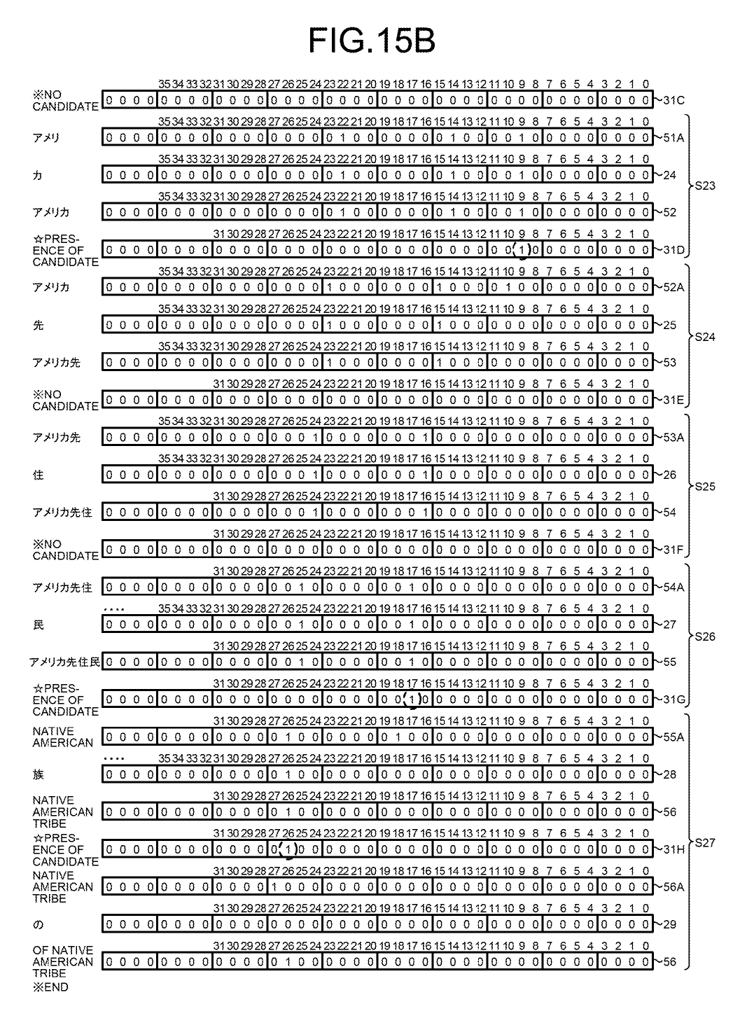

Next, an example of a processing procedure of the information processing apparatus 100 according to the embodiment will be described. FIG. 16 is a flowchart illustrating a processing procedure of the index generation unit. As illustrated in FIG. 16, the index generation unit 151 of the information processing apparatus 100 compares the character string data 142 with a CJK word of the dictionary data 141 (Step S201).

The index generation unit 151 registers a hit character string (CJK word) in the array data 143 (Step S202). The index generation unit 151 generates the index 144′ of each character (CJK character) based on the array data 143 (Step S203). The index generation unit 151 hashes the index 144′ to generate the index data 144 (Step S204).

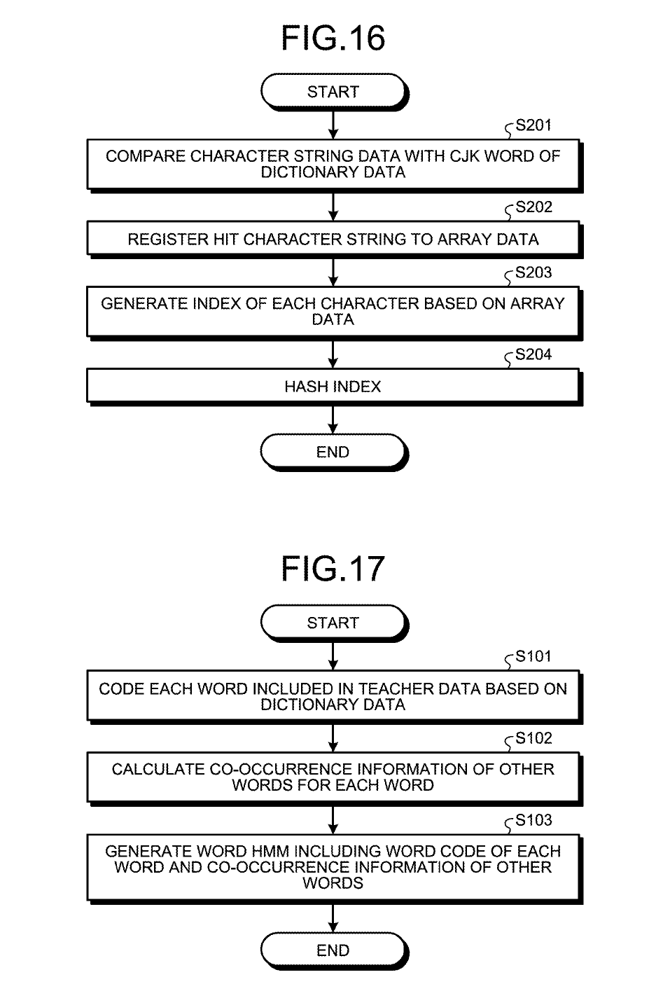

FIG. 17 is a flowchart illustrating a processing procedure of the word HMM generation unit. When receiving the dictionary data 141 and the teacher data 146 used for the morpheme analysis, the word HMM generation unit 152 of the information processing apparatus 100 codes each word included in the teacher data 146 based on the dictionary data 141 (Step S101) as illustrated in FIG. 17.

The word HMM generation unit 152 calculates co-occurrence information of other words included in the teacher data 146 for each word included in the teacher data 146 (Step S102).

The word HMM generation unit 152 generates the word HMM data 147 including the word code of each word and the co-occurrence information of the other words (Step S103). That is, the word HMM generation unit 152 generates the word HMM data 147 including the word code of each word, and the word codes and the co-occurrence rates of the other words.

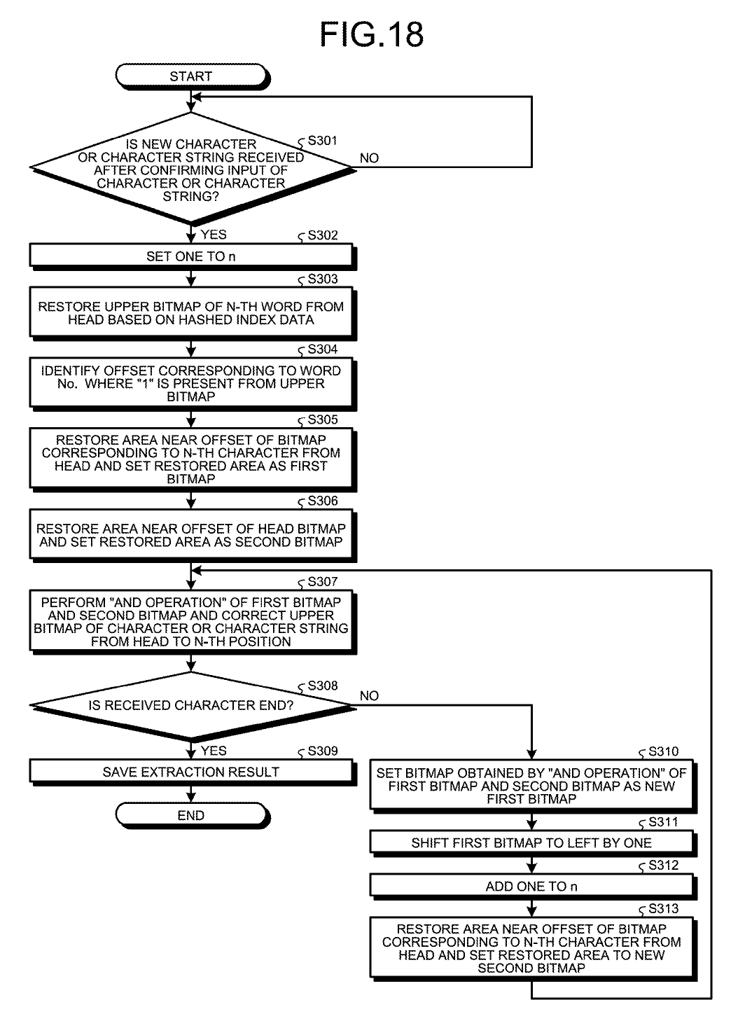

FIG. 18 is a flowchart illustrating a processing procedure of the word candidate extraction unit. As illustrated in FIG. 18, the word candidate extraction unit 153 of the information processing apparatus 100 determines whether a new character or character string has been received after confirming input of a character or character string (Step S301). When it is determined that a new character or character string has not been received (Step S301; No), the word candidate extraction unit 153 repeats the determination process until receiving a new character or character string.

On the other hand, when it is determined that a new character or character string has been received (Step S301; Yes), the word candidate extraction unit 153 sets one to a temporary area n (Step S302). The word candidate extraction unit 153 restores an upper bitmap of the n-th character from the head based on the hashed index data 144 (Step S303).

The word candidate extraction unit 153 refers to the offset table 145 to identify an offset corresponding to the word No. with “1” from the upper bitmap (Step S304). Then, the word candidate extraction unit 153 restores an area near the identified offset of a bitmap corresponding to the n-th character from the head and sets the restored area as a first bitmap (Step S305). The word candidate extraction unit 153 restores an area near the identified offset of a head bitmap and sets the restored area as a second bitmap (Step S306).

The word candidate extraction unit 153 performs an “AND operation” of the first bitmap and the second bitmap and corrects the upper bitmap of the n-th character from the head (Step S307). For example, when an AND result is “0”, the word candidate extraction unit 153 sets a flag “0” at a position corresponding to the word No. of the upper bitmap of characters from the head to the n-th position to correct the upper bitmap.

Then, the word candidate extraction unit 153 determines whether the received character is an end (Step S308). When it is determined that the received character is the end (Step S308: Yes), the word candidate extraction unit 153 saves the extraction result in the storage unit 140 (Step S309). Then, the word candidate extraction unit 153 ends the word candidate extraction process. On the other hand, when it is determined that the received character is not the end (Step S308; No), the word candidate extraction unit 153 sets a bitmap obtained by the “AND operation” of the first bitmap and the second bitmap as a new first bitmap (Step S310).

The word candidate extraction unit 153 shifts the first bitmap to the left by one bit (Step S311). The word candidate extraction unit 153 adds one to the temporary area n (Step S312). The word candidate extraction unit 153 restores an area near an offset of the bitmap corresponding to the n-th character from the head and sets the restored area as a new second bitmap (Step S313). Then, the word candidate extraction unit 153 proceeds to Step S307 so as to perform an AND operation of the first bitmap and the second bitmap.

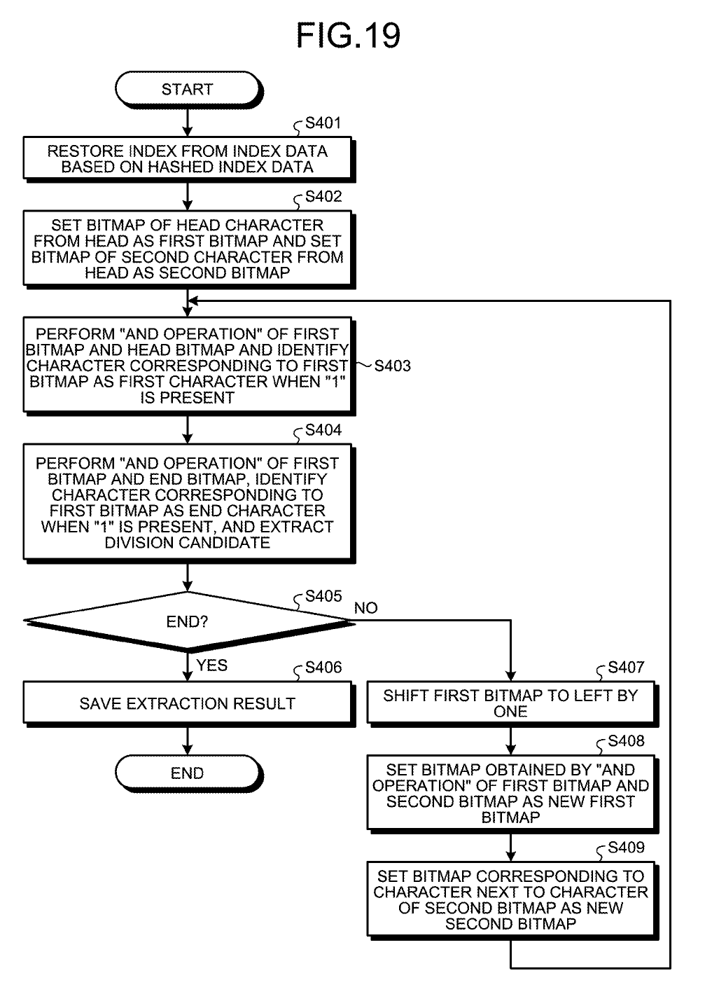

FIG. 19 is a flowchart illustrating a processing procedure of the word extraction unit. As illustrated in FIG. 19, the word extraction unit 154 of the information processing apparatus 100 restores the index 144′ from the hashed index data 144 (Step S401).

The word extraction unit 154 sets a bitmap of the first character from the head of the character string data 142 as a first bitmap and sets a bitmap of the second character from the head as a second bitmap (Step S402).

The word extraction unit 154 performs an “AND operation” of the first bitmap and a head bitmap, and identifies a character corresponding to the first bitmap as a head character when there is “1” in an operation result (Step S403).

The word extraction unit 154 performs an “AND operation” of the first bitmap and an end bitmap, and identifies a character corresponding to the first bitmap as an end character when there is “1” in an operation result and extracts a division candidate (Step S404).

When reaching the end of the character string data 142 (Step S405, Yes), the word extraction unit 154 saves the extraction result in the storage unit 140 (Step S406). Then, the word extraction unit 154 ends the word extraction process.

On the other hand, when not reaching the end of the character string data 142 (Step S405, No), the word extraction unit 154 shifts the first bitmap to the left by one (Step S407). The word extraction unit 154 sets a bitmap obtained by an “AND operation” of the first bitmap and the second bitmap as a new first bitmap (Step S408).

The word extraction unit 154 sets a bitmap corresponding to a character next to a character of the second bitmap as a new second bitmap (Step S409) and proceeds to Step S403.

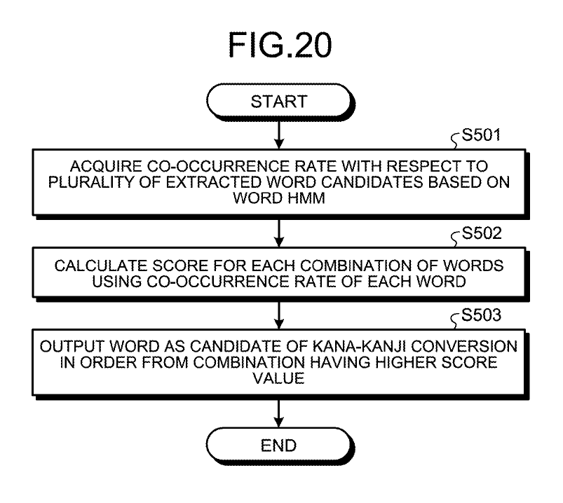

FIG. 20 is a flowchart illustrating a processing procedure of the word estimation unit. In FIG. 20, the processing procedure of the word estimation unit 155 processed in the case of kana-kanji conversion will be described. Here, for example, it is assumed that an upper bitmap of characters from the head to the n-th position is saved as an extraction result extracted by the word candidate extraction unit 153.

As illustrated in FIG. 20, the word estimation unit 155 of the information processing apparatus 100 acquires co-occurrences rates of other co-occurring words for a plurality of word candidates included in the extraction result extracted by the word candidate extraction unit 153, based on the word HMM data 147 (Step S501). For example, the word estimation unit 155 refers to the offset table 145 to identify a word code corresponding to the word No. with “1” from the upper bitmap of the character string from the head to the n-th position. The word estimation unit 155 refers to the word HMM data 147 to acquire co-occurrence information of the other co-occurring words with respect to the identified word code. The co-occurrence information includes, for example, a word code and a co-occurrence rate of the co-occurring word.

The word estimation unit 155 calculates a score for each combination of co-occurring words based on the co-occurrence rate of each co-occurring word with respect to the plurality of word candidates (Step S502). For example, the word estimation unit 155 calculates the score using a co-occurrence rate of a co-occurring word included in (or including) a character or a character string whose input has been confirmed among the co-occurring words indicated by the corresponding co-occurring word code for each identified word code.

The word estimation unit 155 outputs a CJK word indicated by the word candidate for the combination as a candidate for kana-kanji conversion in order from a combination having a higher score value (Step S503). That is, the word estimation unit 155 estimates the CJK word serving as the candidate for kana-kanji conversion corresponding to a character or a character string whose input has been confirmed and a character or a character string that has been newly received and outputs the estimated word in the descending order of scores.

### Effects of Embodiment

Next, effects of the information processing apparatus 100 according to the embodiment will be described. The information processing apparatus 100 receives the dictionary data 141 used for the morpheme analysis. The information processing apparatus 100 generates the index data 144 indicating relative positions of the respective characters of each character included in the word registered in the dictionary data 141, a head character of the word, an end character of the word based on the received dictionary data 141. According to such a configuration, the information processing apparatus 100 can commonize the dictionary data 141 of each of the kana-kanji conversion and the morpheme analysis, and it is possible to efficiently perform word extraction and maximum likelihood estimation by using the index data 144 generated based on the dictionary data 141.

Further, the information processing apparatus 100 receives an operation indicating the confirmation of input of a character or a character string, and then, receives new input of a character or a character string. The information processing apparatus 100 identifies a word including the received character or character string among the words registered in the dictionary data 141 based on the generated index data 144. The information processing apparatus 100 refers to the storage unit 140, which stores the word HMM data 147 including the word information identifying each word registered in the dictionary data 141 and the co-occurrence information of other words for each word to extract any word from among the identified words. According to such a configuration, the information processing apparatus 100 can efficiently perform the extraction of the word serving as the conversion candidate of the kana-kanji conversion and the maximum likelihood estimation by using the index data 144 generated based on the dictionary data 141.

Further, the information processing apparatus 100 receives text data as a processing target to be divided into a plurality of word candidates. The information processing apparatus 100 identifies words included in the received text data among the words registered in the dictionary data 141 based on the generated index data 144. The information processing apparatus 100 refers to the storage unit 140, which stores the word HMM data 147 including the word information identifying each word registered in the dictionary data 141 and the co-occurrence information of other words for each word to extract any word from among the identified words. According to such a configuration, the information processing apparatus 100 can efficiently perform the extraction of the word serving as the division candidate of the morpheme analysis and the maximum likelihood estimation by using the index data 144 generated based on the dictionary data 141.

Further, the information processing apparatus 100 receives the dictionary data 141 and the teacher data 146 used for the morpheme analysis. Then, the information processing apparatus 100 generates the word HMM data 147 including the word code identifying each word registered in the dictionary data 141 and the co-occurrence information of words included in the teacher data 146 for each word based on the dictionary data 141 and the teacher data 146. According to such a configuration, the information processing apparatus 100 can efficiently extract the word candidate that can be subjected to the kana-kanji conversion when the kana-kanji conversion and the morpheme analysis coexist. For example, the information processing apparatus 100 generates the co-occurrence information for each word code, and thus, can reduce the word extraction cost by extracting the word serving as the conversion candidate in accordance with co-occurrence states of other words indicated by the word codes from the word candidates indicated by the word codes. That is, the information processing apparatus 100 can reduce the cost of extracting the word serving as the conversion candidate in the kana-kanji conversion. Further, a conventional word HMM is composed of variable-length character strings, and thus, is large in size, but the word HMM data 147 is composed of word codes instead of variable-length character strings so that reduction in size can be achieved.

Further, the information processing apparatus 100 receives an operation indicating the confirmation of input of a character or a character string, and then, receives new input of a character or a character string. The information processing apparatus 100 refers to the index data 144 indicating the relative positions of the respective characters of each character included in the word registered in the dictionary data 141 used for morpheme analysis, the head character of the word, the end character of the word to perform the following processing The information processing apparatus 100 refers to the generated index data 144 to identify the word including the received character or character string among the words registered in the dictionary data 141. Then, the information processing apparatus 100 extracts any word among the identified words using the word code of the identified word based on the generated word HMM data 147. According to such a configuration, the information processing apparatus 100 can efficiently access the word HMM dependent on the word code in the score calculation of the word HMM in the kana-kanji conversion by using the word code. In other words, the information processing apparatus 100 can reduce cost for extraction of the word in accordance with co-occurrence states of other words from among the identified words in the score calculation of the word HMM in the kana-kanji conversion by using the word code. Further, the information processing apparatus 100 can perform the kana-kanji conversion using the dictionary data 141 used for the morpheme analysis by using the index data 144 and the word HMM data 147. That is, the information processing apparatus 100 can use a word dictionary (the dictionary data 141) for morpheme analysis instead of a word dictionary for kana-kanji conversion. Thus, the information processing apparatus 100 can reduce the data amount of the word dictionary.

Further, the information processing apparatus 100 receives text data as a processing target to be divided into a plurality of word candidates. The information processing apparatus 100 refers to the index data 144 indicating the relative positions of the respective characters of each character included in the word registered in the dictionary data 141 used for morpheme analysis, the head character of the word, the end character of the word to perform the following processing The information processing apparatus 100 identifies words included in the received text data among the words registered in the dictionary data 141. Then, the information processing apparatus 100 extracts any word among the identified words using the word code of the identified word based on the generated word HMM data 147. According to such a configuration, the information processing apparatus 100 can efficiently access the word HMM dependent on the word code in the score calculation of the word HMM in the text analysis of the morpheme analysis by using the word code.

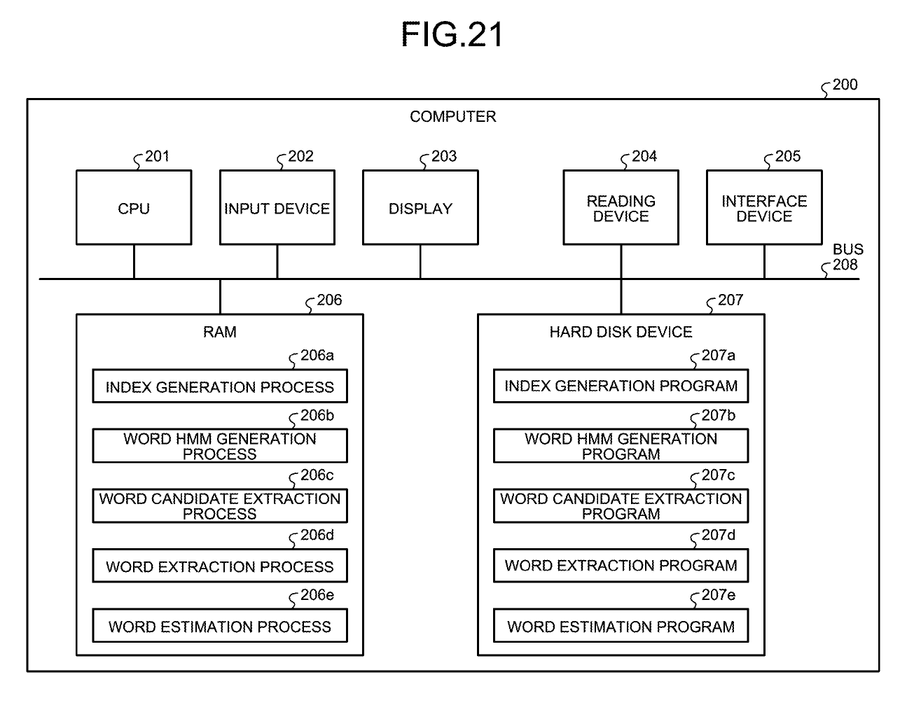

Next, an example of a hardware configuration of a computer that realizes the same functions as those of the information processing apparatus 100 illustrated in the above embodiment will be described. FIG. 21 is a view illustrating an example of a hardware configuration of the computer that realizes the same functions as those of the information processing apparatus.

As illustrated in FIG. 21, a computer 200 includes a CPU 201 which executes various types of arithmetic processing, an input device 202 which receives input of data from a user, and a display 203. Further, the computer 200 includes a reading device 204 which reads a program or the like from a storage medium and an interface device 205 which performs exchange of data with another computer via a wired or wireless network. Further, the computer 200 includes a RAM 206 which temporarily stores various types of information and a hard disk device 207. Further, the respective devices 201 to 207 are connected to a bus 208.

The hard disk device 207 has a word HMM generation program 207a, an index generation program 207b, a conversion candidate extraction program 207c, and a word extraction program 207d. The CPU 201 reads the word HMM generation program 207a, the index generation program 207b, the word candidate extraction program 207c, the word extraction program 207d, and the word estimation program 207e to be developed in the RAM 206.

The index generation program 207a functions as an index generation process 206a. The word HMM generation program 207b functions as a word HMM generation process 206b. The word candidate extraction program 207c functions as a word candidate extraction process 206c. The word extraction program 207d functions as a word extraction process 206d. The word estimation program 207e functions as a word estimation process 206e.

Processing of the index generation process 206a corresponds to the processing of the index generation unit 151. Processing of the word HMM generation process 206b corresponds to the processing of the word HMM generation unit 152. Processing of the word candidate extraction process 206c corresponds to the processing of the word candidate extraction unit 153. Processing of the word extraction process 206d corresponds to the processing of the word extraction unit 154. Processing of the word estimation process 206e corresponds to the processing of the word estimation unit 155.

Incidentally, there is no need to store the respective programs 207a, 207b, 207c, 207d, and 207e in the hard disk device 207 from the beginning. For example, the respective programs may be stored in “portable physical media”, such as a flexible disk (FD), a CD-ROM, the DVD disk, a magneto-optical disk, and an IC card, which are inserted into the computer 200. Then, the computer 200 may be configured to read and execute the respective programs 206a, 206b, 206c, 206d, and 206e.

According to one aspect, it is possible to efficiently perform commonization of word dictionaries of kana-kanji conversion and morpheme analysis, word extraction, and maximum likelihood estimation.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information generation method comprising:
receiving dictionary data used for morpheme analysis; and
generating index information indicating relative positions of characters of each character included in a word registered in the dictionary data, a character at a head of the word, and a character at an end of the word based on the received dictionary data, by a processor.

2. The information generation method according to claim 1, further including:
receiving new input of a character or a character string after an operation indicating confirmation of input of a character or a character string is received;
identifying words including the received character or character string among the words registered in the dictionary data based on the generated index information; and
referring to a storage that stores co-occurring word information including word information identifying each of the words registered in the dictionary data and co-occurrence information of other words with respect to each of the words, and extracting any word among the identified words.

3. The information generation method according to claim 1, further including:
receiving text data as a processing target to be divided into a plurality of word candidates;
identifying words included in the received text data among the words registered in the dictionary data based on the generated index information; and
referring to a storage that stores co-occurring word information including word information identifying each of words registered in the dictionary data and co-occurrence information of other words for each of the words, and extracting any word among the identified words.

4. An information generation method comprising:
receiving dictionary data used for morpheme analysis and text data; and
generating co-occurring word information including word information identifying each of the words registered in the dictionary data and co-occurrence information of a word included in the text data for each of the words based on the dictionary data and the text data, by a processor.

5. The information generation method according to claim 4, further including:
receiving new input of a character or a character string after an operation indicating confirmation of input of a character or a character string is received;
referring to a storage that stores index information indicating relative positions of characters of each character included in a word registered in the dictionary data used for morpheme analysis, a character at a head of the word, and a character at an end of the word, and identifying words including the received character or character string among the words registered in the dictionary data; and
extracting any word among the identified words using word information of the identified words based on the generated co-occurring word information.

6. The information generation method according to claim 4, further including:
receiving text data as a processing target to be divided into a plurality of word candidates;
referring to a storage that stores index information indicating relative positions of characters of each character included in a word registered in the dictionary data used for morpheme analysis, a character at a head of the word, and a character at an end of the word, and identifying words included in the received text data among the words registered in the dictionary data; and
extracting any word among the identified words using word information of the identified words based on the generated co-occurring word information.

7. A word extraction method comprising:
when new input of a character or a character string is received after receiving an operation indicating confirmation of input of a character or character string, referring to a storage that stores index information indicating relative positions of characters of each character included in a word registered in dictionary data used for morpheme analysis, a character at a head of the word, and a character at an end of the word to identify words including the newly received character or character string among the registered words;
referring to a storage that stores, for each word, co-occurrence information of other words with respect to the word to acquire co-occurrence information of the other words with respect to the identified word; and
extracting any word among the identified words based on the acquired co-occurrence information and the character or the character string whose input has been confirmed, by a processor.

8. A word extraction method comprising:
receiving text data as a processing target to be divided into a plurality of word candidates;
referring to a storage that stores index information indicating relative positions of characters of each character included in a word registered in dictionary data used for morpheme analysis, a character at a head of the word, and a character at an end of the word to identify words included in the received text data among the words registered in the dictionary data; and
referring to a storage that stores co-occurring word information including word information identifying each of the words registered in the dictionary data and co-occurrence information of other words with respect to each of the words to extract any word among the identified words, by a processor.

9. An information processing apparatus comprising:
a processor configured to:
generate co-occurring word information including word information identifying each of words registered in dictionary data and co-occurrence information of words included in text data with respect to each of the words based on the dictionary data used for morpheme analysis and the text data;
generate index information indicating relative positions of characters of each character included in a word registered in dictionary data, a character at a head of the word, and a character at an end of the word based on the dictionary data;
identify words including received character or character string among the words registered in the dictionary data based on the index information generated when new input of the character or the character string is received after receiving an operation indicating confirmation of input of a character or a character string, and refer to the co-occurring word information generated to extract any word of the identified words; and
identify words included in the received text data among the words registered in the dictionary data based on the index information generated when receiving the text data, and refer to the co-occurring word information generated to extract any word among the identified words.
